(19) United States
(12) Patent Application Publication
(10) Pub. No.: US 2019/0158602 A1
(43) Pub. Date: May 23, 2019

(54) DATA COLLECTING SYSTEM BASED ON DISTRIBUTED ARCHITECTURE AND OPERATION METHOD THEREOF

(71) Applicant: INSTITUTE FOR INFORMATION INDUSTRY, Taipei City (TW)

(72) Inventors: Kun-Yu LIN, Hemei Township (TW); Chia-Chang Chang, Taichung City (TW); Chih-Chieh Lin, Taipei City (TW); Chien-Chih Lu, Taichung City (TW); Cheng-Tsai Lai, Nantou City (TW); Jun-Ren Chen, Taichung City (TW); Hung-Sheng Chiu, Taichung City (TW)

(73) Assignee: INSTITUTE FOR INFORMATION INDUSTRY, Taipei City (TW)

(21) Appl. No.: 15/833,138

(22) Filed: Dec. 6, 2017

(30) Foreign Application Priority Data
Nov. 20, 2017 (TW) 106140027

(51) Int. Cl. H04L 29/08; G05B 19/02

(52) U.S. Cl. CPC H04L 67/125; H04W 4/006; G05B 19/02

(57) ABSTRACT

A data collecting system includes a management server, a number of data collecting chains. Each data collecting chain includes a computer connected to the management server, at least one sensor and a data acquisition (DAQ), coupled to the sensor(s) and connected to the computer through RS485, configured to acquire sensing data from the sensor(s) and transmit the sensing data to the computer. The DAQs are connected to the computers through a wireless backup transmission interface. The management server sends a first confirmation signal to the computers. When at least one of the computers does not respond to the first confirmation signal, the management server indicates the computers which have responded to the first confirmation signal to receive the sensing data from the DAQ(s) corresponding to the computer(s) which doesn't respond to the first confirmation signal through the wireless backup transmission interface.

This application claims the benefit of Taiwan application Serial No. 106140027, filed Nov. 20, 2017, the disclosure of which is incorporated by reference herein in its entirety.

### BACKGROUND OF THE INVENTION

### Field of the Invention

The invention relates to a data collecting system and an operation method thereof, and especially relates to a data collecting system based on distributed architecture and an operation method thereof.

### Description of the Related Art

With the development of industrial technology, in order to reduce labor costs, automation of plant equipment is nowadays trend. However, due to the reduction in the number of operators may result in failure to detect equipment failure in time. For example, plant equipment typically has many sensors to sense various parameters of the production line, such as temperature, humidity, and the like. Information sensed by these sensors will be captured by the data acquisition and returned to the industrial computer for management. Once the data acquisition or industrial computer failure, the information collected during failure may be lost, and then become an uncertain factor in product quality.

Therefore, in view of problem described above, how to provide a data collecting system based on distributed architecture and operation method thereof is an important topic.

### SUMMARY OF THE INVENTION

The object of the present invention is to provide a data collecting system with a redundant source mechanism and its operation method to solve the problem of information loss during equipment failure.

An embodiment of the present invention discloses a data collecting system includes a management server, a number of data collecting chains. Each of the data collecting chains includes a computer, at least one sensor and a data acquisition (DAQ). The computer is connected to the management server. The DAQ is coupled to the sensor(s) and connected to the computer through RS485. The DAQ is configured to acquire sensing data from the sensor(s) and transmit the sensing data to the computer. The DAQs are connected to the computers through a wireless backup transmission interface. The management server sends a first confirmation signal to the computers. When at least one of the computers does not respond to the first confirmation signal, the management server indicates the computers which have responded to the first confirmation signal to receive the sensing data from the DAQ(s) corresponding to the computer(s) which does not respond to the first confirmation signal through the wireless backup transmission interface.

An embodiment of the present invention discloses an operation method of a data collecting system based on distributed architecture, comprising following steps: sending, by a management server, a first confirmation signal to a plurality of data collecting chains, wherein each of the data collecting chains includes a computer, at least one sensor and a data acquisition (DAQ), the DAQs are connected in communication to the computers through a wireless backup transmission interface, in each of the data collecting chains, the computer communicated with the management server, the DAQ is coupled to the at least one sensor, and connected to the computer through RS485, the DAQ is configured to acquire at least one sensing data from the at least one sensor, and to transmit the sensing data to the computer; determining, by the management server, whether at least one of the computers does not respond to the first confirmation signal; and when the management server determines that at least one of the computers does not respond to the first confirmation signal, indicating, by the management server, the computers which have responded to the first confirmation signal to receive the at least one sensing data sent from the at least one DAQ corresponding to the at least one computer which does not respond to the first confirmation signal.

According to the embodiments of the present invention, the probability of losing the sensing data may be reduced, and the stability of the product quality may be further increased.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a data collecting system based on distributed architecture according to an embodiment of the present invention.

FIG. 2 shows a flowchart of an operation method of a data collecting system based on distributed architecture according to an embodiment of the present invention.

FIGS. 3A and 3B show a flowchart of an operation method of a data collecting system based on distributed architecture according to another embodiment of the present invention.

### DETAILED DESCRIPTION OF THE INVENTION

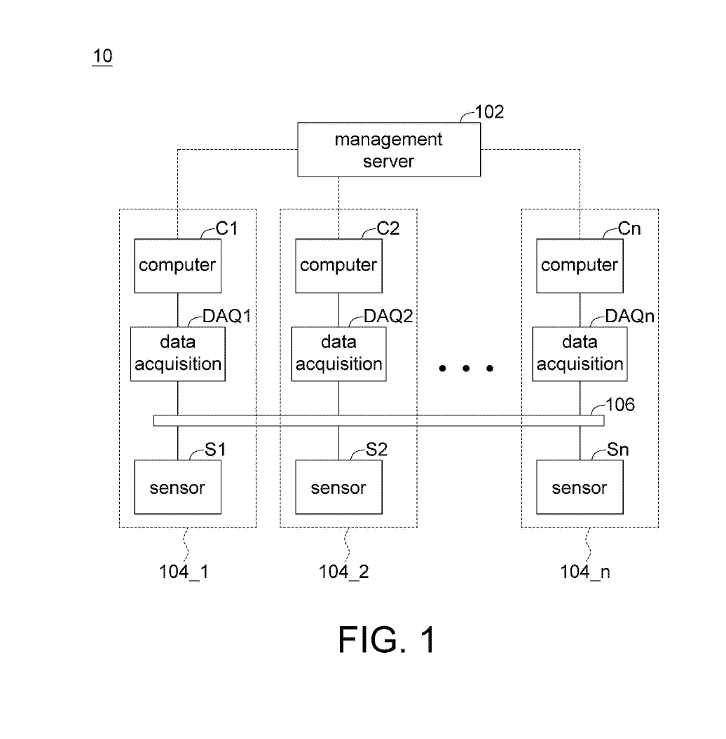

Referring to FIG. 1, FIG. 1 shows a block diagram of a data collecting system based on distributed architecture according to an embodiment of the present invention. The data collecting system 10 includes a management server 102 and a number of data collecting chains 104_1˜104_n. Each data collecting chain 104_i includes a computer Ci, a data acquisition (DAQ) DAQi and at least one sensor Si, where i=1, 2, . . . , n.

The management server 102 may be a cloud server, configured to record and manage information acquired from the data collecting chains 104_1˜104_n.

In each data collecting chain 104_i, the computer Ci may be an industrial computer, or equipment having processing function. The computer Ci may communicate with the management server 102 through Ether net to establish a data transmission path between data collecting chain 104_i and management server 102.

The sensor Si may be configured to sense information of other equipment (not shown) or operating environment, such as temperature of working equipment, humidity of operating environment, and the like. The data acquisition DAQi is coupled to the sensor Si, and is configured to acquire a sensing data sensed by the sensor Si. Additionally, the data acquisition DAQi is connected to the computer Ci through a wire transmission interface, for example, RS485, and transmits the sensing data acquired from the sensor Si to the computer Ci.

Further, at least one electrical bridge device 106 is disposed between the sensors S1˜Sn and data acquisitions DAQ1˜DAQn. By operating the electrical bridge device 106, the sensor Si may be able to be coupled to the DAQ(s) other than the data acquisition DAQi (e.g., the data acquisition close to the data acquisition DAQi). For example, the sensor S1 may be coupled to the data acquisition DAQ2 through the electrical bridge device 106. More specifically, when failure of the data acquisition DAQi occurs, other DAQ(s) without failure may be coupled to the sensor Si through the electrical bridge device 106 to acquire the sensing data from the sensor Si. In other words, Sensing data provided by sensor Si may not be lost due to the data acquisition DAQi failure before failure is eliminated.

Further, the data acquisition DAQi may be able to communicate with the computer(s) other than the computer Ci (e.g., the computer close to the computer Ci) through a wireless backup transmission interface. For example, the data acquisition DAQ1 may communicate with the computer C2 through the wireless backup transmission interface. More specifically, when failure of the computer Ci occurs, other computer(s) without failure may perform data transmission with the data acquisition DAQi through the wireless backup transmission interface to receive the sensing data from the data acquisition DAQi. In other words, sensing data provided by sensor Si may not be lost due to the computer Ci failure before failure is eliminated.

In the embodiment, X-BB may be used as the wireless backup transmission interface, and may be provide by a wireless transmission device (not shown). In other embodiments, wireless backup transmission interface may employ one of the followings: X-bee, Bluetooth, APC220 and Wifi.

It should be noted that, in FIG. 1, each data collecting chain 104_i illustrates only one sensor Si representatively. However, in practical application, each data collecting chain 104_i may include a number of sensors corresponding to a number of sensing targets. In addition, the number of the electrical bridge device 106 may be plural. For example, in an embodiment, the data collecting chains 104_1 and 104_2 may share one electrical bridge device, and the data collecting chains 104_2˜104_5 may share another electrical bridge device.

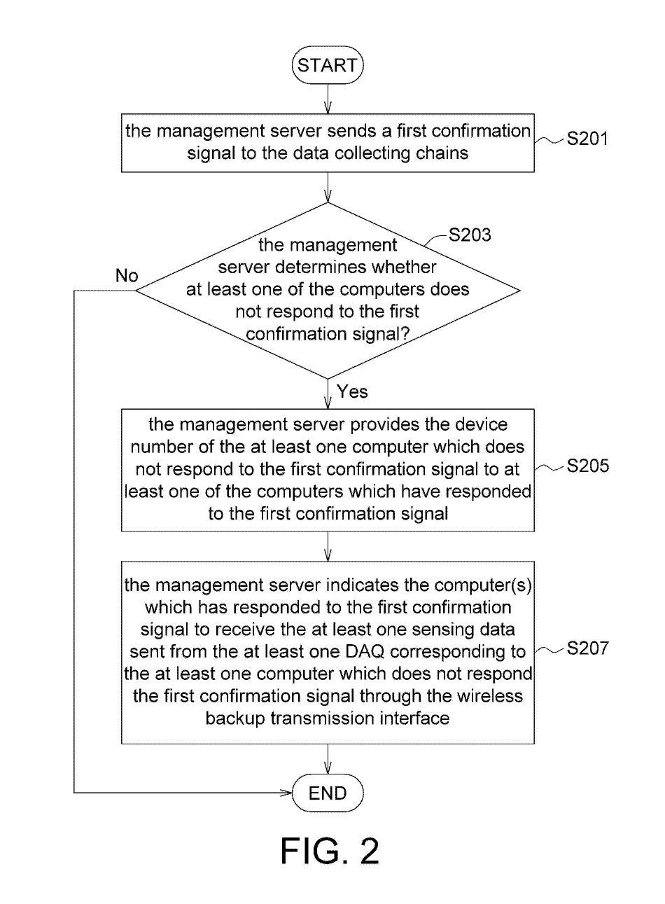

To further understand the present invention, an operation method of the data collecting system 10 will be described below with referring to FIG. 2. As shown in FIG. 2, the operation method of the data collecting system includes steps S201˜S207.

In step S201, the management server 102 may send a first confirmation signal to the data collecting chains 104_1˜104_n, for example, by broadcasting.

In step S203, the management server 102 determines whether at least one of the computers does not respond to the first confirmation signal. In general, the computers C1˜Cn may be configured to respond to the first confirmation signal when the computers C1˜Cn are in a normal state. That is, when one of the computers is in a state that the computer is unable to respond to the first confirmation signal, the management server 102 may determine that the computer which does not respond to the first confirmation signal is in an abnormal state if no response is received from the computer.

In step S205, the management server 102 provides the device number of the at least one computer which does not respond to the first confirmation signal to at least one of the computers which have responded to the first confirmation signal. For example, it is assumed that the computer C1 is in the abnormal state so that the computer C1 does not respond to the first confirmation signal. The management server 102 may provide the device number of the computer C1 to the computer C2.

In step S207, the management server 102 indicates the computer(s) which has responded to the first confirmation signal to receive the at least one sensing data sent from the at least one DAQ corresponding to the at least one computer which does not respond the first confirmation signal through the wireless backup transmission interface. For example, when the computer C1 is in the abnormal state, the management server 102 may indicate the computer C2 to receive the sensing data from the data acquisition DAQ1. Further, after the computer C2 received the indication from the management server 102, the computer C2 may inform the data acquisition DAQ1 through the wireless backup transmission interface to indicate the data acquisition DAQ1 to transmit the sensing data to the computer C2 through the wireless backup transmission interface rather than transmit the sensing data to the computer C1 through the wire transmission interface.

In addition, the computers C1˜Cn may include a backup relationship table. The backup relationship table records backup relationship among the computers C1˜Cn. The backup relationship table may be stored in the computers C1˜Cn, or pre-set in the hardware when installing the computers C1˜Cn. After the management server 102 finds out that a computer is in the abnormal state and notifies the other computers which are normally functioning, the normally functioning computer(s) may afford the work of the computer in the abnormal state according to the backup relationship table.

In other words, in this embodiment, the wireless backup transmission interface provides a data transmission path, when at least one of the computers is in the abnormal state, the sensing data may be transmitted wirelessly to the computer(s) which is normally functioning, and then transmitted to the management server 102 by the computer(s) which is normally functioning, so that the probability of occurrence of sensing data loss may be reduced.

It should be noted that the step S205 is optional. For example, in some other embodiments, two data collecting chains may be grouped as a group, and two computers in each data collecting chain are a backup of each other. When the computer in one of the data collecting chains is in the abnormal state, the management server may send information that inform abnormal state occurring to the other computer which is normally functioning without providing the device number.

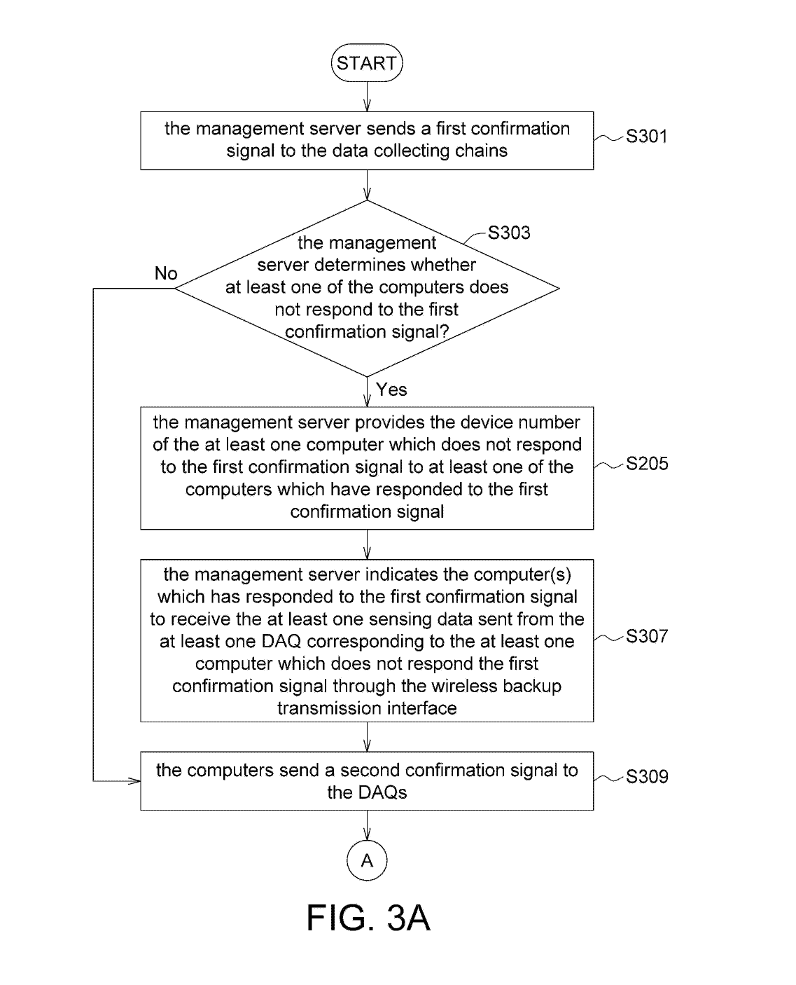

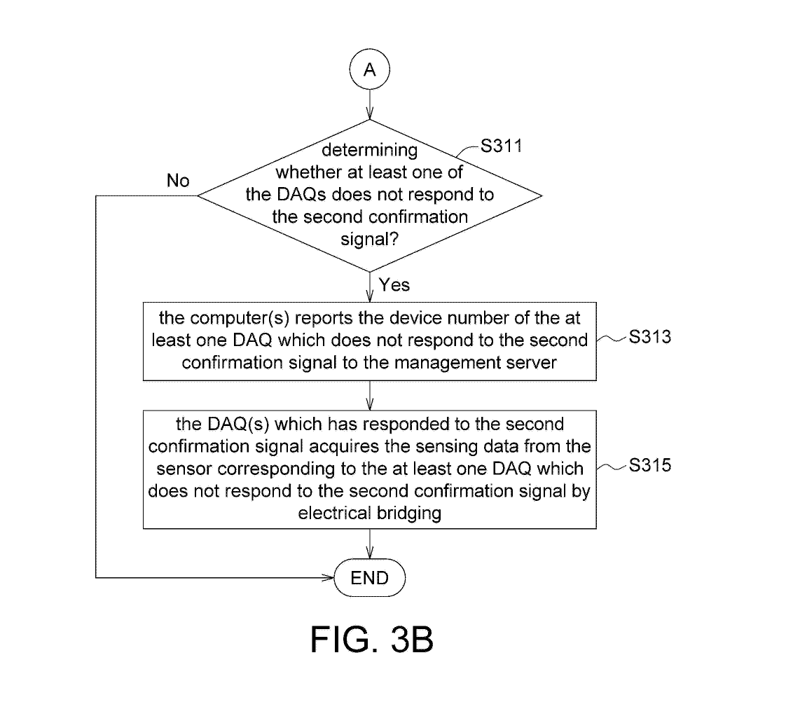

Referring to FIGS. 3A and 3B, FIGS. 3A and 3B show a flowchart of an operation method of a data collecting system based on distributed architecture according to another embodiment of the present invention. In this embodiment, the operation method includes steps S301˜S3015, where the steps S301˜S307 are similar to the steps S201˜S207 of the previous embodiment, and may not be described repeatedly.

In step S309, each computer Ci may send a second confirmation signal to the data acquisition DAQi corresponding to the computer, for example, through the wire transmission interface. In some other embodiments, the computers C1˜Cn may send the second confirmation signal to the data acquisitions DAQ1˜DAQn by broadcasting. The present invention is not limited by.

In step S311, determining whether at least one of the DAQs does not respond to the second confirmation signal. In general, the data acquisitions DAQ1˜DAQn may be configured to respond to the second confirmation signal when the data acquisitions DAQ1˜DAQn are in the normal state. That is, when one of the DAQs is in a state that the DAQ is unable to respond to the second confirmation signal, the corresponding computer may determine that the DAQ which does not respond to the second confirmation signal is in the abnormal state if no response is received.

In step S313, the computer(s) reports the device number of the at least one DAQ which does not respond to the second confirmation signal to the management server 102. The step S313 is optional. When the step S313 is performed, the management server 102 may establish more complete abnormal history records. By referring to the abnormal history records, it may be able to know the frequency of abnormal occurrence of each data acquisition DAQi and determine whether there is any need for further maintenance or replacement.

In step S315, the DAQ(s) which has responded to the second confirmation signal acquires the sensing data from the sensor corresponding to the at least one DAQ which does not respond to the second confirmation signal by electrical bridging. Further, the electrical bridging may practice by the electrical bridge device 106. When at least one of the DAQs is in the abnormal state, the electrical bridge device 106 may be controlled by the management server 102 or at least one of the computers to couple the sensor corresponding to the DAQ which is in the abnormal state with DAQ which is normally functioning. Additionally, the backup relationship among the data acquisitions DAQ1˜DAQn may be pre-set according to the backup relationship table, or be assigned by the management server 102 (for example, when step S313 is performed).

That is, compared with the previous embodiment, this embodiment provides a data transmission path by electrical bridging. When at least one of the DAQs is in the abnormal state, the sensed data may be transmitted to the DAQ which is normally functioning by electrical bridging, and then be sent to the computer by the DAQ which is normally functioning, so that the probability of occurrence of sensing data loss may be reduced.

In conclusion, according to the embodiments of the present invention, the management server confirms whether any computer is in the abnormal state by sending a first confirmation signal. When there a computer is in the abnormal state, the wireless backup transmission interface provides a backup data transmission path to transmit the sensing data; the computer confirms whether any DAQ is in the abnormal state by sending the second confirmation signal, when there is a DAQ is in the abnormal state, by way of electrical bridging may provide another backup data transmission path to transmit the sensing data. With the mechanism described above, the probability of losing the sensing data may be reduced, and the stability of the product quality may be further increased. In addition, by managing the abnormal history records by the management server, anomalous alerts may be issued immediately, so that the time it takes to find the failure to troubleshoot may be shortened. Moreover, by referring to the abnormal history records, it may be able to know the frequency of abnormal occurrence of equipment and determine whether there is any need for further maintenance or replacement.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data collecting system based on distributed architecture, comprising:
a management server; and
a plurality of data collecting chains, each of the data collecting chains including:
a computer, communicated with the management server;
at least one sensor; and
a data acquisition (DAQ), coupled to the at least one sensor, and connected to the computer through RS485, the DAQ configured to acquire at least one sensing data from the at least one sensor, and to transmit the sensing data to the computer,
wherein the DAQs are connected in communication to the computers through a wireless backup transmission interface,
wherein the management server sends a first confirmation signal to the computers and in response to at least one of the computers does not respond to the first confirmation signal, the management server indicates the computers which have responded to the first confirmation signal to receive the at least one sensing data sent from the at least one DAQ corresponding to the at least one computer which does not respond to the first confirmation signal.

2. The data collecting system based on distributed architecture according to claim 1, wherein the computers send a second confirmation signal to the DAQs, and in response to at least one of the DAQs does not respond to the second confirmation signal, the DAQs which have responded to the second confirmation signal acquire the at least one sensing data from the at least one sensor corresponding to the at least one DAQ which does not respond to the second confirmation signal by electrical bridging.

3. The data collecting system based on distributed architecture according to claim 2, wherein in response to at least one of the DAQs does not respond to the second confirmation signal, the computers report a device number of the at least one DAQ which does not respond to the second confirmation signal to the management server.

4. The data collecting system based on distributed architecture according to claim 1, wherein the wireless backup transmission interface includes one of the followings: X-BB, X-bee, Bluetooth, APC220 and Wifi.

5. The data collecting system based on distributed architecture according to claim 1, wherein in response to at least one of the computers does not respond to the first confirmation signal, the management server provides a device number of the at least one computer which does not respond to the first confirmation signal to at least one of the computers which has responded to the first confirmation signal.

6. An operation method of a data collecting system based on distributed architecture, comprising:
sending a first confirmation signal to a plurality of data collecting chains by a management server, wherein each of the data collecting chains includes a computer, at least one sensor and a data acquisition (DAQ), the DAQs are connected in communication to the computers through a wireless backup transmission interface, in each of the data collecting chains, the computer communicated with the management server, the DAQ is coupled to the at least one sensor, and connected to the computer through RS485, the DAQ is configured to acquire at least one sensing data from the at least one sensor, and to transmit the sensing data to the computer;
determining whether at least one of the computers does not respond to the first confirmation signal by the management server; and
in response to the management server determines that at least one of the computers does not respond to the first confirmation signal, indicating, by the management server, the computers which have responded to the first confirmation signal to receive the at least one sensing data sent from the at least one DAQ corresponding to the at least one computer which does not respond to the first confirmation signal.

7. The operation method according to claim 6, further comprising:
sending a second confirmation signal to the DAQs by the computers; and
in response to the computers determines that at least one of the DAQs does not respond to the second confirmation signal, acquiring, by the DAQs which have responded to the second confirmation signal, the at least one sensing data from the at least one sensor corresponding to the at least one DAQ which does not respond to the second confirmation signal by electrical bridging.

8. The operation method according to claim 7, further comprising:
in response to at least one of the DAQs does not respond to the second confirmation signal, reporting, by the computers, the device number of the at least one DAQ which does not respond to the second confirmation signal to the management server.

9. The operation method according to claim 6, wherein the wireless backup transmission interface includes one of the followings: X-BB, X-bee, Bluetooth, APC220 and Wifi.

10. The operation method according to claim 6, wherein after the step of determining, by the management server, whether at least one of the computers does not respond to the first confirmation signal, further comprising:
in response to at least one of the computers does not respond to the first confirmation signal, providing, by the management server, the device number of the at least one computer which does not respond to the first confirmation signal to at least one of the computers which has responded to the first confirmation signal.
